(19) United States
(12) Patent Application Publication
(10) Pub. No.: US 2006/0198971 A1
(43) Pub. Date: Sep. 7, 2006

(54) Thermal transfer sheet

(75) Inventors: Naohiro Obonai, Tokyo-To (JP); Keiichi Ogawa, Tokyo-To (JP)

Correspondence Address: BURR & BROWN, PO BOX 7068, SYRACUSE, NY, 13261-7068, US

(73) Assignee: Dai Nippon Printing Co., Ltd., Shinjuku-Ku (JP)

(21) Appl. No.: 11/364,818

(22) Filed: Feb. 28, 2006

(30) Foreign Application Priority Data
Mar. 1, 2005 (JP) 2005-56620

(51) Int. Cl. B41M 5/40

(52) U.S. Cl. 428/32.86

(57) ABSTRACT

A thermal transfer sheet comprising: a base material sheet; and a thermally transferable transfer layer provided on at least a part of one side of the base material sheet, wherein the transfer layer is formed of at least two polyester resins, and one of the two polyester resins is a polyester resin having a glass transition point of 50° C. or above and a number average molecular weight of 2000 to 20000, an alcohol component in the polyester resin being composed of an aliphatic alcohol alone, and the other polymer resin is a polyester resin satisfying one or both of property requirements (a) and (b): (a) a bisphenol A component being present as an alcohol component, and the number average molecular weight being not more than 25000; and (b) a softening point of 110° C. or below as measured by a ring and ball method specified in JIS K 5601-2-2.

### TECHNICAL FIELD

The present invention relates to a thermal transfer sheet comprising a base material sheet and a thermally transferable transfer layer provided on at least a part of one side of the base material sheet and more particularly to a thermal transfer sheet which can exhibit a good balance of functions, that is, a good balance between a property that, in a nontransfer period, the transfer layer is not easily separated from the base material sheet, that is, a good layer retaining property, and a property that, in separation while hot and separation while cold at the time of the thermal transfer, the separability of the transfer layer from the base material sheet is good.

### BACKGROUND ART

A heat-fusion transfer or thermal ink transfer method has hitherto been known in which a thermal transfer sheet comprising a base material sheet, such as a plastic film, bearing thereon a colored layer formed of a colorant such as a pigment or a dye dispersed in a binder such as a heat-fusible wax or resin is provided and energy according to image information is applied to a heating device such as a thermal head to transfer the colorant together with the binder onto an image-receiving sheet such as paper or a plastic sheet. Images produced by the heat-fusion transfer have high density and possess high sharpness and are suitable for recording binary images of characters, line images or the like. Further, a multicolor or full-color image can also be formed by subtractive mixing, that is, by providing a thermal transfer sheet comprising colored layers such as yellow, magenta, cyan, and black color layers and superimposing each colored layer onto an image-receiving sheet using the thermal transfer sheet to perform printing and recording.

Line images such as characters and numerals can easily be formed by the heat-fusion transfer method. For some type of colored layers, however, the fastness properties of the formed image, particularly, abrasion resistance, are not good. A thermal dye transfer or thermal dye sublimation transfer method is also known as the thermal transfer method. In this thermal dye sublimation transfer method, a sublimable dye contained in a colored layer is transferred onto an image receiving sheet upon exposure to heat to form a thermally transferred image. The thermal dye sublimation transfer method is suitable for the formation of gradational images such as a photograph of the face, but on the other hand, is disadvantageous in that, unlike images formed by conventional printing ink, due to the absence of a vehicle, the formed images are poor in fastness properties such as abrasion resistance and, further, upon contact of the images, for example, with plasticizer-containing card cases, file sheets, or plastic erasers, the transfer of the dye thereto or blurring of the images occurs, that is, are also poor in chemical resistance, solvent resistance and the like. Accordingly, in order to impart an improvement in fastness properties such as abrasion resistance, chemical resistance, and solvent resistance to the formed images, the provision of a protective layer on the thermally transferred image by transfer using a protective layer transfer sheet comprising a thermally transferable protective layer provided on a base material sheet has been carried out.

Both the colored layer to be transferred by the above fusion transfer method and the protective layer to be transferred by thermal transfer from the protective layer transfer sheet are transfer layers to be fusion-transferred by heating. The colored layer contains a colorant and is transferred onto an image receiving sheet to form a thermally transferred color image. The protective layer is transferred onto the image receiving sheet with a thermally transferred image or the like formed thereon to protect and to impart fastness properties to a layer (for example, a thermally transferred image) underlying the protective layer. In this case, the protective layer should be transparent from the viewpoint of avoiding concealing the underlying image or the like upon transfer of the protective layer.

In the thermal transfer sheet comprising the colored layer and the layer (transfer layer) transferable by heat, such as a protective layer, provided on a base material sheet, the separability in a nontransfer state should be low (that is, the adhesion to the base material sheet should be good), while, at the time of the thermal transfer, the separability should be high and stable separation should be realized. In order to improve the separability at the time of thermal transfer, for example, in Japanese Patent Laid-Open No. 277899/1999 and Japanese Patent Laid-Open No. 127558/2003, a release layer has been provided between the base material sheet and the transfer layer to overcome the above problems. Since, however, the additional provision of the release layer additionally requires, for example, the step of forming a release layer in the production process and further requires the cost of materials for constituting the release layer, the thermal transfer sheet cannot be prepared at low cost. Further, a silicone resin is in many cases used as the resin in the release layer, and, consequently, the adhesion in a nontransfer state is sometimes insufficient. When the adhesion in a nontransfer state is insufficient, disadvantageously, there is a fear of causing falling of the transfer layer. On the other hand, when a resin having good adhesion to the base material sheet is used in the transfer layer in order to improve the adhesion in a nontransfer state, the heat temperature range usable for the transfer of the transfer layer is narrow. Immediately after the thermal transfer, the transfer layer is likely to be melted and transferred. On the other hand, when the transfer layer is separated from the base material sheet while cold in such a state that the transfer layer is cooled after the elapse of about 30 sec from the thermal transfer, in some cases, the thermal transfer layer cannot be separated from the base material sheet.

### DISCLOSURE OF THE INVENTION

Accordingly, the present invention is directed to the solution of the problems involved in the prior art, and an object of the present invention is to provide a thermal transfer sheet, comprising a transfer layer provided on a base material sheet, in which, in a nontransfer state, the transfer layer is not easily separated from the base material sheet, that is, the layer retaining property is good, while, at the time of thermal transfer, the separability of the transfer layer is good, and, further, the separability of the transfer layer is good in both the case where the thermal transfer sheet is separated from the image receiving sheet immediately after the thermal transfer (separation while hot) and the case where the thermal transfer sheet is separated from the image receiving sheet when the transfer layer is in a cold state after a certain time period has elapsed after the thermal transfer (separation while cold).

The above object can be attained by a thermal transfer sheet comprising: a base material sheet; and a thermally transferable transfer layer provided on at least a part of one side of the base material sheet, wherein said transfer layer is formed of at least two polyester resins, and one of the two polyester resins is a polyester resin having a glass transition point of 50° C. or above and a number average molecular weight of 2000 to 20000, an alcohol component in the polyester resin being composed of an aliphatic alcohol alone, and the other polymer resin is a polyester resin satisfying one of or both a property requirement (a) and a property requirement (b):

(a) the presence of a bisphenol A component as an alcohol component, and the number average molecular weight being not more than 25000; and

(b) a softening point of 110° C. or below as measured by a ring and ball method specified in JIS K 5601-2-2.

In a preferred embodiment of the present invention, the mixing ratio between the two polyester resins in the transfer layer is polyester resin of which the alcohol component is composed of an aliphatic alcohol alone/polyester resin satisfying one of or both a property requirement (a) and a property requirement (b)=0.5/99.5 to 20/80.

In another preferred embodiment of the present invention, the transfer layer comprises a colorant and an acrylic resin.

In a further preferred embodiment of the present invention, said transfer layer comprises an acrylic resin, is transparent and is transferred onto an image receiving sheet to function as a protective layer for the image receiving sheet. Further, an adhesive layer may be provided on the transfer layer.

Furthermore, in the present invention, one of or both the front surface and the back surface of the thermal transfer sheet may have an antistatic property.

As described above, the present invention provides a thermal transfer sheet comprising: a base material sheet; and a thermally transferable transfer layer provided on at least a part of one side of the base material sheet, wherein said transfer layer is formed of at least two polyester resins, and one of the two polyester resins is a polyester resin having a glass transition point of 50° C. or above and a number average molecular weight of 2000 to 20000, an alcohol component in the polyester resin being composed of an aliphatic alcohol alone, and the other polymer resin is a polyester resin satisfying one of or both a property requirement (a) and a property requirement (b):

(a) the presence of a bisphenol A component as an alcohol component, and the number average molecular weight being not more than 25000; and

(b) a softening point of 110° C. or below as measured by a ring and ball method specified in JIS K 5601-2-2.

As described above, in the transfer layer, a polyester resin, which has a glass transition point of 50° C. or above and a number average molecular weight of 2000 to 20000 and in which the alcohol component in the polyester resin is composed of an aliphatic alcohol alone, is mainly used as a polyester resin having good adhesion to a base material sheet such as a polyethylene terephthalate film. Further, in the transfer layer, a polyester resin satisfying one of or both a property requirement (a) and a property requirement (b) is mainly used as a polyester resin having good separability from the base material sheet in both separation while hot in the thermal transfer and separation while cold. By virtue of this construction, a thermal transfer sheet is provided which has good balance between the matter that the transfer layer in a nontransfer state is not easily separated from the base material sheet, that is, has good layer retaining property, and the matter that the separability of the transfer layer from the base material sheet in the thermal transfer is good in both separation while hot and separation while cold.

### BRIEF DESCRIPTION OF THE DRAWINGS

FIG. 1 is a schematic diagram showing one embodiment of the thermal transfer sheet according to the present invention; and

FIG. 2 is a schematic diagram showing another embodiment of the thermal transfer sheet according to the present invention.

### BEST MODE FOR CARRYING OUT THE INVENTION

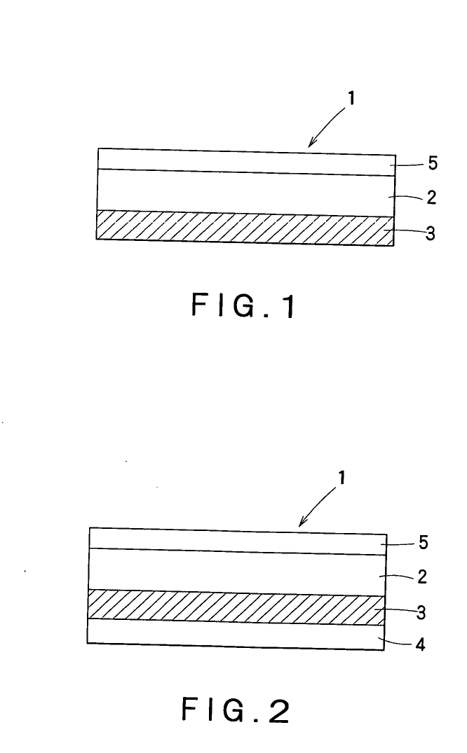

FIG. 1 is a schematic diagram showing one embodiment of a thermal transfer sheet 1 according to the present invention. The construction of the thermal transfer sheet 1 is such that a transfer layer 3 is provided on one side of a base material sheet 2, and a backside layer 5 is provided on the other side of the base material sheet 2. FIG. 2 is a schematic diagram showing another embodiment of a thermal transfer sheet 1 according to the present invention. The construction of the thermal transfer sheet 1 is such that a transfer layer 3 and an adhesive layer 4 are provided in that order on one side of a base material sheet 2, and a backside layer 5 is provided on the other side of the base material sheet 2. The construction of the thermal transfer sheet according to the present invention is not limited to the embodiments shown in these drawings. For example, an antistatic layer may also be provided on one of or both the front surface and the back surface of the thermal transfer sheet. The individual layers constituting the thermal transfer sheet according to the present invention will be described in detail.

(Base Material Sheet)

The same base material sheet as used in the conventional thermal transfer sheet as such may be used as the base material sheet 2 used in the thermal transfer sheet of the present invention, and other base material sheets may also be used without particular limitations. Specific examples of preferred base materials include, for example, plastic films such as films of polyesters, polypropylenes, cellophanes, polycarbonates, acetylcelluloses, polyethylenes, polyvinyl chlorides, polystyrenes, nylons, polyimides, polyvinylidene chlorides, polyvinyl alcohols, fluororesins, chlorinated rubbers, and ionomers, and papers such as capacitor papers and paraffin-waxed papers, or composites of these materials. The thickness of the base material sheet may be properly varied depending upon materials so that the strength and the thermal conductivity of the base material sheet are proper. From the viewpoint of the relationship between these properties and the printing (recording) sensitivity, the thickness is preferably about 2 to 12 μm. That is, when the thickness is less than 2 μm, the strength as the base material sheet is likely to be unsatisfactory. On the other hand, when the thickness exceeds 12 μm, the heat in printing (recording) is less likely to be transferred to the transfer layer.

(Transfer Layer)

The transfer layer 3 used in the thermal transfer sheet according to the present invention comprises at least two polyester resins, and one of the two polyester resins is a polyester resin having a glass transition point of 50° C. or above and a number average molecular weight of 2000 to 20000, an alcohol component in the polyester resin being composed of an aliphatic alcohol alone, and the other polymer resin is a polyester resin satisfying one of or both a property requirement (a) and a property requirement (b):

(a) the presence of a bisphenol A component as an alcohol component, and the number average molecular weight being not more than 25000; and

(b) a softening point of 110° C. or below as measured by a ring and ball method specified in JIS K 5601-2-2.

In the polyester resin in which the alcohol component is composed of an aliphatic alcohol only, examples of aliphatic alcohols include aliphatic diols such as ethylene glycol, propylene glycol, 1,3-propanediol, 2,3-butanediol, 1,4-butanediol, 1,5-pentanediol, 1,6-hexanediol, neopentyl glycol, diethylene glycol, dipropylene glycol, dimethylolheptane, 2,2,4-trimethyl-1,3-pentanediol, polyethylene glycol, polypropylene glycol, and polytetramethylene glycol, and triols and tetraols such as trimethylolethane, trimethylolpropane, glycerin, and pentaerythritol.

The polyester resin in which the alcohol component is composed of an aliphatic alcohol only is produced by polycondensation of the alcohol component with an acid component. Such acid components include the following polycarboxylic acids. Polycarboxylic acids include, for example, aromatic dicarboxylic acids such as terephthalic acid, isophtalic acid, orthophthalic acid, 1,5-naphthalenedicarboxylic acid, 2,6-naphthalenedicarboxylic acid, and diphenic acid, aromatic oxycarboxylic acids such as p-oxybenzoic acid and p-(hydroxyethoxy)benzoic acid, aliphatic dicarboxylic acids such as succinic acid, alkylsuccinic acid, alkenylsuccinic acid, adipic acid, azelaic acid, sebacic acid, dodecanedicarboxylic acid, and unsaturated aliphatic and alicyclic dicarboxylic acids such as fumaric acid, maleic acid, itaconic acid, mesaconic acid, citraconic acid, hexahydrophthalic acid, tetrahydrophthalic acid, dimer acid, trimer acid, hydrogenated dimer acid, cyclohexanedicarboxylic acid, and cyclohexenedicarboxylic acid. Other polycarboxylic acids usable herein include tri- or higher polycarboxylic acids such as trimellitic acid, trimesic acid, and pyromellitic acid.

The polyester resin in which the alcohol component is composed of an aliphatic alcohol only should satisfy a glass transition point of 50° C. or above and a number average molecular weight of 2000 to 20000. When the glass transition point is below 50° C., the heat resistance of the polyester resin is lowered, and, thus, an unfavorable phenomenon such as blocking of the transfer layer against the backside with which the transfer layer comes into contact, occurs during storage of a roll of thermal transfer sheet under an elevated temperature or the like. Likewise, when the number average molecular weight of the polyester resin is smaller than 2000, an unfavorable phenomenon such as blocking of the transfer layer against the backside with which the transfer layer comes into contact, is likely to occur during storage of a roll of thermal transfer sheet under an elevated temperature or the like. On the other hand, when the number average molecular weight is more than 20000, the adhesion to the base material sheet is disadvantageously deteriorated.

The transfer layer in the thermal transfer sheet according to the present invention is formed of a mixture of the polyester resin in which the alcohol component is composed of an aliphatic alcohol only and the polyester resin satisfying one of or both the following property requirements (a) and (b):

(a) the presence of a bisphenol A component as an alcohol component, and the number average molecular weight being not more than 25000; and

(b) a softening point of 110° C. or below as measured by a ring and ball method specified in JIS K 5601-2-2.

The polyester resin comprising a bisphenol A component as the alcohol component and having a number average molecular weight of not more than 25000 may be such that the alcohol component contains a diol component of ethylene oxide or propylene oxide adduct of bisphenol A or hydrogenated bisphenol A and, in this case, other alicyclic alcohols or aliphatic alcohols may also be used in combination therewith. When the number average molecular weight of the polyester resin is more than 25000, the separability of the transfer layer from the base material sheet in the thermal transfer is lowered.

Regarding the polyester resin having a softening point of 110° C. or below as measured by a ring and ball method specified in JIS K 5601-2-2, the structure is not limited, for example, to the aliphatic or alicyclic structure so far as the softening point as measured by a ring and ball method specified in JIS K 5601-2-2 is 110° C. or below. When the softening point of the polyester resin is above 110° C., the separability of the transfer layer from the base material sheet in the thermal transfer is lowered.

The transfer layer contains two polyester resins, that is, (1) a polyester resin having a glass transition point of 50° C. or above and a number average molecular weight of 2000 to 20000, an alcohol component in the polyester resin being composed of an aliphatic alcohol alone and (2) a polyester resin satisfying one of or both the following property requirements (a) and (b). Polyester resins not satisfying the above requirements may be added in such an amount range that does not adversely affect the function of the transfer layer in the thermal transfer sheet according to the present invention.

(a) A bisphenol A component is contained as an alcohol component, and the number average molecular weight is not more than 25000.

(b) The softening point is 110° C. or below as measured by a ring and ball method specified in JIS K 5601-2-2.

The mixing ratio between the two polyester resins in the transfer layer is preferably polyester resin of which the alcohol component is composed of an aliphatic alcohol alone/polyester resin satisfying one of or both a property requirement (a) and a property requirement (b)=0.5/99.5 to 20/80. In this mixing ratio, when the content of the polyester resin in which the alcohol component is composed of an aliphatic alcohol only is excessively low, there is no problem of the separability of the transfer layer from the base material sheet in the thermal transfer. In this case, however, the adhesion between the transfer layer and the base material sheet is lowered, and, in handling the thermal transfer sheet, the transfer layer is likely to come off from the base material sheet. On the other hand, when the content of the polyester resin in which the alcohol component is composed of an aliphatic alcohol only is above the upper limit of the above-defined range, the separability of the transfer layer from the base material sheet in the thermal transfer is lowered although there is no problem of the adhesion between the transfer layer and the base material sheet.

In addition to the polyester resin, an acrylic resin may be added to the transfer layer. This can improve fastness properties such as abrasion resistance of the transferred layer after the transfer of the transfer layer onto an image receiving sheet and, when a color pigment is added to the transfer layer, the dispersibility of the pigment can be improved. According to the present invention, the acrylic resin is a polymer comprising at least one monomer selected from conventional acrylate monomers and methacrylate monomers. In addition to the acrylic monomer, for example, styrene or acrylonitrile may be used as a comonomer. The monomer is preferably methyl methacrylate, and the monomer component preferably contains methyl methacrylate in an amount of not less than 50% by mass in terms of charge mass ratio.

Conventional acrylic monomers usable herein include: methyl acrylate, methyl methacrylate, ethyl acrylate, ethyl methacrylate, propyl acrylate, propyl methacrylate, butyl acrylate, butyl methacrylate, isobutyl acrylate, isobutyl methacrylate, tert-butyl acrylate, tert-butyl methacrylate, isodecyl acrylate, isodecyl methacrylate, lauryl acrylate, lauryl methacrylate, lauryltridecyl acrylate, lauryltridecyl methacrylate, tridecyl acrylate, tridecyl methacrylate, cetylstearyl acrylate, cetylstearyl methacrylate, stearyl acrylate, stearyl methacrylate, 2-ethylhexyl acrylate, 2-ethylhexyl methacrylate, octyl acrylate, octyl methacrylate, cyclohexyl acrylate, cyclohexyl methacrylate, benzyl acrylate, benzyl methacrylate, phenoxyethyl acrylate, phenoxyethyl methacrylate, isobornyl acrylate, isobornyl methacrylate, dicyclopentenyl acrylate, dicyclopentenyl methacrylate, methacrylic acid, 2-hydroxyethyl acrylate, 2-hydroxyethyl methacrylate, 2-hydroxypropyl acrylate, 2-hydroxypropyl methacrylate, dimethylaminoethyl acrylate, dimethylaminoethyl methacrylate, diethylaminoethyl acrylate, diethylaminoethyl methacrylate, tert-butylaminoethyl acrylate, tert-butylaminoethyl methacrylate, glycidyl acrylate, glycidyl methacrylate, tetrahydrofurfuryl acrylate, and tetrahydrofurfuryl methacrylate.

Other acrylic monomers include ethylene diacrylate, ethylene dimethacrylate, diethylene glycol diacrylate, diethylene glycol dimethacrylate, triethylene glycol diacrylate, triethylene glycol dimethacrylate, tetraethylene glycol diacrylate, tetraethylene glycol dimethacrylate, decaethylene glycol diacrylate, decaethylene glycol dimethacrylate, pentadecaethylene glycol diacrylate, pentadecaethylene glycol dimethacrylate, pentacontahectaethylene glycol diacrylate, pentacontahectaethylene glycol dimethacrylate, butylene diacrylate, butylene dimethacrylate, allyl acrylate, allyl methacrylate, trimethylolpropane triacrylate, trimethylolpropane trimethacrylate, 1,6-hexanediol diacrylate, 1,6-hexanediol dimethacrylate, tripropylene glycol diacrylate, tripropylene glycol dimethacrylate, pentaerythritol tetraacrylate, pentaerythritol tetramethacrylate, dipentaerythritol hexaacrylate, dipentaerythritol hexamethacrylate, neopentyl glycol pentaacrylate, neopentyl glycol pentamethacrylate, phosphazene hexaacrylate, and phosphazene hexamethacrylate. The acrylic resin according to the present invention preferably has a number average molecular weight of not less than 20,000 and not more than 100,000. When the number average molecular weight is less than 20,000, an oligomer is produced during the synthesis of the resin and, consequently, stable properties cannot be obtained. On the other hand, when the number average molecular weight exceeds 100,000, the separability of the transfer layer from the base material sheet in the thermal transfer is lowered.

In the transfer layer, the acrylic resin may be mixed in an amount of 10 to 700 parts by mass based on 100 parts by mass in total of the above-described plurality of polyester resins. The glass transition point of the acrylic resin used is about 90 to 110° C.

The transfer layer in the thermal transfer sheet according to the present invention is melted and transferred upon heating. If necessary, a colorant is added to the transfer layer, and the transfer layer is used as a colorant layer and is transferred onto an image receiving sheet to form a thermally transferred colored image. Alternatively, a method may be adopted in which no colorant is added to the transfer layer and the transfer layer is transferred onto an image receiving sheet to protect and to impart fastness properties to a layer (such as a thermally transferred image) underlying the transferred layer, that is, to form a transparent protective layer.

When the transfer layer is used as a colored layer, a colorant is contained in the transfer layer. Colorants such as yellow, magenta, cyan, black, and white colorants are properly selected from conventional dyes and pigments. The transfer layer comprises the above polyester resin as an indispensable ingredient. If necessary, an acrylic resin and a colorant may be added. Further, assistants such as plasticizers, surfactants, lubricants, and fluidity modifiers may be added. A coating liquid prepared by dissolving or dispersing the above components in a solvent is coated onto a base material sheet by a conventional method such as gravure direct coating, gravure reverse coating, knife coating, air coating, or roll coating to a thickness of about 0.1 to 5.0 g/m², preferably 0.5 to 2.0 g/m², on a dry basis. When the thickness of the dried coating film is less than 0.1 g/m², an even film is not formed due to a problem of film forming properties. On the other hand, when the thickness exceeds 5 g/m², disadvantageously, high energy is required for print transfer and, consequently, printing can be carried out only by a special thermal transfer printer.

(Adhesive Layer)

In the thermal transfer sheet according to the present invention, a transfer layer 3 and an adhesive layer 4 may be formed in that order on a base material sheet to improve the adhesion of the thermally transferred layer to the image receiving sheet and to realize firm adhesion. Regarding the resin constituting the adhesive layer 4, a resin having a suitable glass transition temperature is preferably selected, for example, from resins having good adhesion while hot, for example, polyester resins, polycarbonate resins, butyral resins, ultraviolet absorbing resins, epoxy resins, vinyl chloride-vinyl acetate copolymer resins, polyamide resins, and vinyl chloride resins. Ultraviolet absorbing resins are particularly preferred because they can be transferred onto the image receiving sheet to impart lightfastness to prints.

For example, resins prepared by reacting and bonding a reactive ultraviolet absorber to a thermoplastic resin or an ionizing radiation curing resin may be used as the ultraviolet absorbing resin. More specific examples thereof include those prepared by introducing a reactive group such as an addition-polymerizable double bond, such as a vinyl group, an acryloyl group or a methacryloyl group, or an alcoholic hydroxyl, amino, carboxyl, epoxy, or isocyanate group, into a conventional nonreactive organic ultraviolet absorber such as a salicylate, benzophenone, benzotriazole, substituted acrylonitrile, nickel chelate, or hindered amine ultraviolet absorber. The adhesive layer is preferably formed by providing a coating liquid, prepared by adding the resin for constituting the adhesive layer and optionally antiblocking agents such as waxes, amides, esters and salts of higher fatty acids, fluororesins, and powders of inorganic materials such as silica, or other additives, coating the coating liquid by a conventional method as described above in connection with the transfer layer, and drying the coating to form an adhesive layer having a thickness of about 0.5 to 10 g/m² on a dry basis.

(Antistatic Layer)

In the thermal transfer sheet according to the present invention, a layer having antistatic properties, that is, an antistatic layer, may be provided on one of or both the front surface and the back surface of the thermal transfer sheet to prevent the occurrence of troubles during transfer of the thermal transfer sheet in a thermal transfer printer, for example, static electricity-derived troubles. Conventional antistatic agents may be used as the antistatic agent without particular limitation. Specific examples of the antistatic agent include carbon black, electrically conductive metals such as nickel, aluminum, cobalt, chromium, magnesium, molybdenum, palladium, rhodium, tin, tantalum, titanium, tungsten, indium, cadmium, ruthenium, zirconium, iron, lead, platinum, zinc, gold, silver, and copper, electrically conductive metal oxides such as oxides of the above metals, zinc antimonate (ZnO.Sb₂O₅), tin oxide (SnO₂), indium oxide (InO₃), and cadmium oxide (CdO), electrically conductive resins such as stearate, methacrylate, ethoxylate, and acrylate resins, and surfactants such as quaternary ammonium salts, carboxylic acid salts, sulfonic acid salts, sufric ester salts, and phosphoric ester salts. The electrically conductive metal oxide preferably has a particle diameter in the range of 10 to 100 nm as measured by a dynamic light scattering method. When the particle diameter is less than 10 nm, the addition amount of the electrically conductive metal oxide should be large for maintaining the electrical conductivity. On the other hand, a particle diameter exceeding 100 nm is disadvantageously causative of rough surface upon the transfer and is further causative of lowered transparency.

When the electrically conductive metal, the electrically conductive metal oxide or the like is used as the antistatic agent, the antistatic layer is formed by dispersing the antistatic agent in the following binder resin and applying the dispersion. When the electrically conductive resin is used as the antistatic agent, there is no need to use any binder resin. Binder resins include polyolefin resins such as polypropylene, halogenated polymers such as polyvinyl chloride and polyvinylidene chloride, vinyl resins such as polyvinyl acetate and polyacrylic ester, polyester resins such as polyethylene terephthalate and polybutylene terephthalate, polystyrene resins, polyamide resins, ionomers, cellulose resins such as cellulose acetate, polycarbonate resins, polyvinyl acetal resins, and polyvinyl alcohol resins, and copolymer resins of the above resins or monomers thereof such as vinyl chloride-vinyl acetate copolymer and ethylene-vinyl acetate copolymer.

The antistatic layer is formed by dissolving or dispersing the above necessary materials in a solvent, coating the coating liquid by a conventional method, and drying the coating to form a layer having a thickness of about 0.001 to 0.1 g/m² on a dry basis. The antistatic layer may be provided separately from the transfer layer and the backside layer. Alternatively, the above antistatic agent may be added to the transfer layer and/or the backside layer to impart antistatic properties.

(Backside Layer)

In the thermal transfer sheet according to the present invention, if necessary, a backside layer 5 may be provided on the backside of the base material, that is, on the base material in its surface remote from the transfer layer, to prevent adverse effect such as sticking or cockling caused by heat from a thermal head or the like as the thermal transfer means. The resin usable for forming the backside layer may be any conventional resin, and examples thereof include polyvinylbutyral resins, polyvinylacetoacetal resins, polyester resins, vinyl chloride-vinyl acetate copolymers, polyether resins, polybutadiene resins, styrene-butadiene copolymers, acrylic polyols, polyurethane acrylates, polyester acrylates, polyether acrylates, epoxy acrylates, urethane or epoxy prepolymers, nitrocellulose resins, cellulose nitrate resins, cellulose acetopropionate resins, cellulose acetate butyrate resins, cellulose acetate hydrogenphthalate resins, cellulose acetate resins, aromatic polyamide resins, polyimide resins, polycarbonate resins, and chlorinated polyolefin resins.

Slipperiness-imparting agents added to or coated onto the top of the backside layer formed of these resins include phosphoric esters, silicone oils, graphite powders, silicone graft polymers, fluoro graft polymers, acrylic silicone graft polymers, acrylsiloxanes, arylsiloxanes, and other silicone polymers. Preferably, the layer is formed of a polyol, for example, a polyalcohol polymer compound, a polyisocyanate compound, or a phosphoric ester compound. Further, the addition of a filler is more preferred. The backside layer may be formed by dissolving or dispersing the above resin, slipperiness-imparting agent, and filler in a suitable solvent to prepare an ink for backside layer formation, coating the ink onto the backside of the base material sheet, for example, by forming means such as gravure printing, screen printing, or reverse roll coating using a gravure plate, and drying the coating. A thickness satisfactory for fusing preventive or lubrication purposes or the like suffices for the backside layer, and the thickness of the backside layer is generally about 0.1 to 3 g/m² on a dry basis.

The image receiving sheet used in combination with the thermal transfer sheet according to the present invention is not particularly limited, and examples thereof include plain papers, wood free papers, art papers, coated papers, cast coated papers, tracing papers, synthetic papers (polyolefin or polystyrene papers), synthetic resin- or emulsion-impregnated papers, synthetic rubber latex-impregnated papers, papers with synthetic resins internally added thereto, and sheets and three-dimensional molded products of various plastics and the like. The shape of the image receiving sheet may be any of cards, postal cards, passports, letter papers or writing pads, report pads, notebooks, catalogs, cups, cases, building materials, panels, telephones, radios, televisions or other electronic components, rechargeable batteries and the like. Further, white opaque films formed by adding a white pigment or a filler to a synthetic resin for constituting various plastic films or sheets and forming a film, or foamed sheets may also be used. Furthermore, an image receiving sheet formed by forming a conventional dye receptive layer, formed of a dye receptive resin containing a release agent, onto an image receiving surface formed of the above material may also be used. In this case, preferably, a thermal transfer sheet comprising a sublimable dye-containing dye layer as the dye receptive layer is used for the thermal transfer of a dye image, and a protective layer as the transfer layer in the thermal transfer sheet according to the present invention is transferred to cover the dye image.

### EXAMPLES

The following Examples further illustrate the present invention. In the following Examples, “parts” or “%” is by mass unless otherwise specified.

### Example 1

A coating liquid for a backside layer having the following composition was coated by wire bar coating onto one side of a 4.5 μm-thick biaxially stretched polyethylene terephthalate film (Lumirror, manufactured by Toray Industries, Inc.) as a base material sheet at a coverage of 1.0 g/m² on a dry basis, and the coating was dried at 100° C. for 60 sec to form a backside layer. Next, a coating liquid for a transfer layer having the following composition was gravure coated onto the base material sheet in its surface remote from the backside layer at a coverage of 1.0 g/m² on a dry basis, and the coating was dried at 80° C. for 60 sec to form a transfer layer. Thus, a thermal transfer sheet of Example 1 was prepared.

(Composition of Coating Liquid for Backside Layer)

| | | |
|---|---|---|
| Acrylonitrile-styrene copolymer | 11 | parts |
| Linear saturated polyester resin | 0.3 | part |
| Zinc stearyl phosphate | 6 | parts |
| Melamine resin powder | 3 | parts |
| Toluene/ethanol = 50/50 (mass ratio) | 80 | parts |

(Composition of Coating Liquid 1 for Transfer Layer)

| | | |
|---|---|---|
| Colorant | 17.50 | parts |
| Polyester resin A1 | 0.05 | part |
| Polyester resin B1 | 9.95 | parts |
| Acrylic resin (glass transition point 105° C.) | 7.80 | parts |
| Toluene/methyl ethyl ketone = 50/50 (mass ratio) | 64.60 | parts |

Polyester resin A1 has a glass transition point of 50° C. or above and a number average molecular weight of 2000 to 20000, and the alcohol component in polyester resin A1 is composed of an aliphatic alcohol alone. More specifically, polyester resin A1 has a glass transition point of 67° C. and a number average molecular weight of 20000, and the alcohol component comprises 50% by mole of ethylene glycol and 50% by mole of neopentyl glycol. On the other hand, polyester resin B1 is a polyester resin satisfying one of or both the following property requirements (a) and (b): (a) a bisphenol A component is present as an alcohol component, and the number average molecular weight is not more than 25000; and (b) the softening point is 110° C. or below as measured by a ring and ball method specified in JIS K 5601-2-2. More specifically, polyester resin B1 has property requirement (a), contains a bisphenol A component as the alcohol component, has a number average molecular weight of 22000, and has a softening point of 160° C. (above 110° C.) as measured by a ring and ball method specified in JIS K 5601-2-2.

### Example 2

A thermal transfer sheet of Example 2 was prepared in the same manner as in Example 1, except that, in the preparation of the thermal transfer sheet, the coating liquid for a transfer layer was changed to a coating liquid having the following composition.

(Composition of Coating Liquid 2 for Transfer Layer)

| | | |
|---|---|---|
| Colorant | 17.50 | parts |
| Polyester resin A1 | 1.00 | part |
| Polyester resin B1 | 4.00 | parts |
| Acrylic resin (glass transition point 105° C.) | 12.80 | parts |
| Toluene/methyl ethyl ketone = 50/50 (mass ratio) | 64.60 | parts |

Polyester resins A1 and B1 are the same as those used in Example 1.

### Example 3

A thermal transfer sheet of Example 3 was prepared in the same manner as in Example 1, except that, in the preparation of the thermal transfer sheet, the coating liquid for a transfer layer was changed to a coating liquid having the following composition.

(Composition of Coating Liquid 3 for Transfer Layer)

| | | |
|---|---|---|
| Colorant | 17.50 | parts |
| Polyester resin A2 | 0.05 | part |
| Polyester resin B2 | 9.95 | parts |
| Acrylic resin (glass transition point 105° C.) | 7.80 | parts |
| Toluene/methyl ethyl ketone = 50/50 (mass ratio) | 64.60 | parts |

Polyester resin A2 has a glass transition point of 50° C. or above and a number average molecular weight of 2000 to 20000, and the alcohol component in polyester resin A2 is composed of an aliphatic alcohol alone. More specifically, polyester resin A2 has a glass transition point of 53° C. and a number average molecular weight of 2000, and the alcohol component comprises 50% by mole of ethylene glycol and 50% by mole of neopentyl glycol. On the other hand, polyester resin B2 is a polyester resin satisfying one of or both the following property requirements (a) and (b): (a) a bisphenol A component is contained as an alcohol component, and the number average molecular weight is not more than 25000; and (b) the softening point is 110° C. or below as measured by a ring and ball method specified in JIS K 5601-2-2. More specifically, polyester resin B2 is an aliphatic polyester resin that satisfies property requirement (b), has a softening point of 110° C. as measured by a ring and ball method specified in JIS K 5601-2-2, and does not contain a bisphenol A component as the alcohol component.

### Example 4

A thermal transfer sheet of Example 4 was prepared in the same manner as in Example 1, except that, in the preparation of the thermal transfer sheet, the coating liquid for a transfer layer was changed to a coating liquid having the following composition.

(Composition of Coating Liquid 4 for Transfer Layer)

| | | |
|---|---|---|
| Colorant | 17.50 | parts |
| Polyester resin A2 | 1.00 | part |
| Polyester resin B2 | 4.00 | parts |
| Acrylic resin (glass transition point 105° C.) | 12.80 | parts |
| Toluene/methyl ethyl ketone = 50/50 (mass ratio) | 64.60 | parts |

Polyester resins A2 and B2 are the same as those used in Example 3.

### Example 5

A thermal transfer sheet of Example 5 was prepared in the same manner as in Example 1, except that, in the preparation of the thermal transfer sheet, the coating liquid for a transfer layer was changed to a coating liquid having the following composition.

(Composition of Coating Liquid 5 for Transfer Layer)

| | | |
|---|---|---|
| Colorant | 17.50 | parts |
| Polyester resin A1 | 0.05 | part |
| Polyester resin B3 | 9.95 | parts |
| Acrylic resin (glass transition point 105° C.) | 7.80 | parts |
| Toluene/methyl ethyl ketone = 50/50 (mass ratio) | 64.60 | parts |

Polyester resin A1 is the same as that used in Example 1. Polyester resin B3 is a polyester resin satisfying one of or both the following property requirements (a) and (b): (a) a bisphenol A component is contained as an alcohol component, and the number average molecular weight is not more than 25000; and (b) the softening point is 110° C. or below as measured by a ring and ball method specified in JIS K 5601-2-2. More specifically, polyester resin A1 is a polyester resin that satisfies both property requirements (a) and (b), contains a bisphenol A component as the alcohol component, has a number average molecular weight of 15000, and has a softening point of 105° C. as measured by a ring and ball method specified in JIS K 5601-2-2.

### Example 6

A thermal transfer sheet of Example 6 was prepared in the same manner as in Example 1, except that, in the preparation of the thermal transfer sheet, the coating liquid for a transfer layer was changed to a coating liquid having the following composition.

(Composition of Coating Liquid 6 for Transfer Layer)

| | | |
|---|---|---|
| Colorant | 17.50 | parts |
| Polyester resin A1 | 1.00 | part |
| Polyester resin B3 | 4.00 | parts |
| Acrylic resin (glass transition point 105° C.) | 12.80 | parts |
| Toluene/methyl ethyl ketone = 50/50 (mass ratio) | 64.60 | parts |

Polyester resins A1 and B3 are the same as those used in Example 5.

### Example 7

A thermal transfer sheet of Example 7 was prepared in the same manner as in Example 1, except that, in the preparation of the thermal transfer sheet, the coating liquid for a transfer layer was changed to a coating liquid having the following composition.

(Composition of Coating Liquid 7 for Transfer Layer)

| | | |
|---|---|---|
| Polyester resin A1 | 0.4 | part |
| Polyester resin B1 | 4.6 | parts |
| Acrylic resin (glass transition point 105° C.) | 30.4 | parts |
| Toluene/methyl ethyl ketone = 50/50 (mass ratio) | 64.6 | parts |

Polyester resins A1 and B1 are the same as those used in Example 1.

### Example 8

A thermal transfer sheet of Example 8 was prepared in the same manner as in Example 1, except that, in the preparation of the thermal transfer sheet, the coating liquid for a transfer layer was changed to a coating liquid having the following composition.

(Composition of Coating Liquid 8 for Transfer Layer)

| | | |
|---|---|---|
| Polyester resin A1 | 0.4 | part |
| Polyester resin B2 | 4.6 | parts |
| Acrylic resin (glass transition point 105° C.) | 30.4 | parts |
| Toluene/methyl ethyl ketone = 50/50 (mass ratio) | 64.6 | parts |

Polyester resin A1 is identical to the polyester resin used in Example 1 that has a glass transition point of 50° C. or above and a number average molecular weight of 2000 to 20000 and contains only an aliphatic alcohol as the alcohol component. Polyester resin B2 is identical to the polyester resin used in Example 3 that satisfies property requirement (b) that the softening point is 110° C. or below as measured by a ring and ball method specified in JIS K 5601-2-2.

### Example 9

A thermal transfer sheet of Example 9 was prepared in the same manner as in Example 1, except that, in the preparation of the thermal transfer sheet, the coating liquid for a transfer layer was changed to a coating liquid having the following composition.

(Composition of Coating Liquid 9 for Transfer Layer)

| | | |
|---|---|---|
| Polyester resin A1 | 0.4 | part |
| Polyester resin B3 | 4.6 | parts |
| Acrylic resin (glass transition point 105° C.) | 30.4 | parts |
| Toluene/methyl ethyl ketone = 50/50 (mass ratio) | 64.6 | parts |

Polyester resins A1 and B3 are the same as those used in Example 5.

### Example 10

A thermal transfer sheet was prepared in the same manner as in Example 1, except that, in the preparation of the thermal transfer sheet, the coating liquid for a transfer layer was changed to a coating liquid having the following composition. A coating liquid for an adhesive layer having the following composition was gravure coated at a coverage of 1.5 g/m² on a dry basis onto the transfer layer, and the coating was dried at 100° C. for 60 sec to form an adhesive layer. Thus, a thermal transfer sheet of Example 10 was prepared.

(Composition of Coating Liquid 10 for Transfer Layer)

| | | |
|---|---|---|
| Polyester resin A1 | 0.4 | part |
| Polyester resin B3 | 4.6 | parts |
| Acrylic resin (glass transition point 105° C.) | 30.4 | parts |
| Toluene/methyl ethyl ketone = 50/50 (mass ratio) | 64.6 | parts |

Polyester resins A1 and B3 are the same as those used in Example 5.

(Composition of Coating Liquid for Adhesive Layer)

| | | |
|---|---|---|
| Polyester resin (glass transition point 47° C., | 24 | parts |
| number average molecular weight 16000) | | |
| Ultraviolet absorbing acrylic copolymer resin | 6 | parts |
| Toluene/methyl ethyl ketone = 50/50 (mass ratio) | 70 | parts |

### Example 11

A thermal transfer sheet was prepared in the same manner as in Example 1, except that, in the preparation of the thermal transfer sheet, the coating liquid for a transfer layer was changed to a coating liquid having the following composition. A coating liquid for an adhesive layer having the following composition was gravure coated at a coverage of 1.5 g/m² on a dry basis onto the transfer layer, and the coating was dried at 1° C. for 60 sec. Thus, a thermal transfer sheet of Example 11 was prepared.

(Composition of Coating Liquid 11 for Transfer Layer)

| | | |
|---|---|---|
| Colorant | 17.5 | parts |
| Polyester resin A1 | 0.4 | part |
| Polyester resin B3 | 4.6 | parts |
| Acrylic resin (glass transition point 105° C.) | 12.1 | parts |
| Polyethylene wax | 0.7 | part |
| Toluene/methyl ethyl ketone = 50/50 (mass ratio) | 64.6 | parts |

Polyester resins A1 and B3 are the same as those used in Example 5.

### Comparative Example 1

A thermal transfer sheet of Comparative Example 1 was prepared in the same manner as in Example 1, except that, in the preparation of the thermal transfer sheet, the coating liquid for a transfer layer was changed to a coating liquid having the following composition.

(Composition of Coating Liquid 11 for Transfer Layer)

| | | |
|---|---|---|
| Colorant | 17.5 | parts |
| Polyester resin A1 | 1.0 | part |
| Acrylic resin (glass transition point 105° C.) | 17.8 | parts |
| Toluene/methyl ethyl ketone = 50/50 (mass ratio) | 64.6 | parts |

Polyester resin A1 is identical to the polyester resin used in Example 1 that has a glass transition point of 50° C. or above and a number average molecular weight of 2000 to 20000 and contains only an aliphatic alcohol as the alcohol component.

### Comparative Example 2

A thermal transfer sheet of Comparative Example 2 was prepared in the same manner as in Example 1, except that, in the preparation of the thermal transfer sheet, the coating liquid for a transfer layer was changed to a coating liquid having the following composition.

(Composition of Coating Liquid 12 for Transfer Layer)

| | | |
|---|---|---|
| Colorant | 17.50 | parts |
| Polyester resin A1 | 0.05 | part |
| Acrylic resin (glass transition point 105° C.) | 17.75 | parts |
| Toluene/methyl ethyl ketone = 50/50 (mass ratio) | 64.60 | parts |

Polyester resin A1 is identical to the polyester resin used in Example 1 that has a glass transition point of 50° C. or above and a number average molecular weight of 2000 to 20000 and contains only an aliphatic alcohol as the alcohol component.

### Comparative Example 3

A thermal transfer sheet of Comparative Example 3 was prepared in the same manner as in Example 1, except that, in the preparation of the thermal transfer sheet, the coating liquid for a transfer layer was changed to a coating liquid having the following composition.

(Composition of Coating Liquid 13 for Transfer Layer)

| | | |
|---|---|---|
| Colorant | 17.5 | parts |
| Polyester resin B1 | 10.0 | parts |
| Acrylic resin (glass transition point 105° C.) | 7.8 | parts |
| Toluene/methyl ethyl ketone = 50/50 (mass ratio) | 64.6 | parts |

Polyester resin B1 is identical to the polyester resin used in Example 1 that satisfies a property requirement (a) that a bisphenol A component is contained as the alcohol component and the number average molecular weight is not more than 25000.

### Comparative Example 4

A thermal transfer sheet of Comparative Example 4 was prepared in the same manner as in Example 1, except that, in the preparation of the thermal transfer sheet, the coating liquid for a transfer layer was changed to a coating liquid having the following composition.

(Composition of Coating Liquid 14 for Transfer Layer)

| | | |
|---|---|---|
| Colorant | 17.5 | parts |
| Polyester resin B2 | 10.0 | parts |
| Acrylic resin (glass transition point 105° C.) | 7.8 | parts |
| Toluene/methyl ethyl ketone = 50/50 (mass ratio) | 64.6 | parts |

Polyester resin B2 is identical to the polyester resin used in Example 3 that satisfies a property requirement (b) that the softening point is 110° C. or below as measured by a ring and ball method specified in JIS K 5601-2-2.

### Comparative Example 5

A thermal transfer sheet of Comparative Example 5 was prepared in the same manner as in Example 1, except that, in the preparation of the thermal transfer sheet, the coating liquid for a transfer layer was changed to a coating liquid having the following composition.

(Composition of Coating Liquid 15 for Transfer Layer)

| | | |
|---|---|---|
| Colorant | 17.5 | parts |
| Polyester resin B3 | 10.0 | parts |
| Acrylic resin (glass transition point 105° C.) | 7.8 | parts |
| Toluene/methyl ethyl ketone = 50/50 (mass ratio) | 64.6 | parts |

Polyester resin B3 is identical to the polyester resin used in Example 5 that satisfies a property requirement (a) that a bisphenol A component is contained as the alcohol component and the number average molecular weight is not more than 25000, and a property requirement (b) that the softening point is 110° C. or below as measured by a ring and ball method specified in JIS K 5601-2-2.

The thermal transfer sheets prepared in the above Examples and Comparative Examples were tested for adhesion to the base material sheet and separability at the time of thermal transfer (separability immediately after heating and separability after 30 sec) by the following methods.

(Adhesion to Base Material Sheet)

Cello-Tape (registered trademark) (No. 405-1P, for industrial applications, 18 mm in width×70 m in length, manufactured by Nichiban Co., Ltd.) was applied to the transfer layer side of each thermal transfer sheet by rubbing the tape by one reciprocation with the thumb against the transfer layer side of each thermal transfer sheet. Immediately after the application, the tape was subjected to 180-degree peeling to visually confirm whether or not the transfer layer is transferred to the tape side. Evaluation criteria were as follows.

⊚: The transfer layer was not transferred to the tape side at all.

◯: The transfer layer was slightly transferred to a part of the tape side on such a level that does not pose any problem.

x: The transfer layer was almost entirely transferred to the tape side.

(Separability at the Time of Thermal Transfer)

Printing was carried out using each thermal transfer sheet on a film manufactured by Sekisui Chemical Co., Ltd. (tradename: Tack Paint, color number TP02) as an object under the following printing conditions. The prints were used for the evaluation of separability.

(Printing Conditions)

Thermal head: KGT-217-12 MPL20 (manufactured by Kyocera Corp.)

Heating element average resistance value: 3195 (Ω)

Printing density in main scanning direction: 300 dpi

Printing density in feed direction: 300 dpi

Applied power: 0.13 (w/dot)

One line period: 5 (msec.)

Printing initiation temp.: 40 (° C)

Gradation control method: A test printer of a multi-pulse system was provided which had such a pulse length that one line period was divided into 256 equal parts and wherein the number of divided pulses could be varied from 0 to 255 during one line period. The duty ratio of each divided pulse was fixed at 80%, and transfer was carried out in 255 gradations in a range from the printing start part to the printing end part. The print range was 100 mm in length (printing direction)×55 mm in width.

(Separability at the Time of Thermal Transfer) (Separability Immediately after Heating)

Immediately after printing under the above conditions, the thermal transfer sheet was separated from an object (an image receiving sheet) by hand. The force necessary for the separation by hand was sensorily evaluated. The evaluation criteria were as follows.

⊚: Easily separable

◯: Separable

x: Difficult to separate

(Separability at the Time of Thermal Transfer) (Separability after 30 Sec)

Upon the elapse of 30 sec after printing under the above conditions, the force necessary for separating the thermal transfer sheet from the object (peel force) was measured using a T-shaped peeling tool specified in JIS P 8139 under the following conditions with HEIDON 140R, manufactured by Shinto Scientific Company Ltd.

Measuring conditions: Test table travel speed 1000 mm/min; travel distance 100 mm

The evaluation criteria were as follows.

⊚: A peel force of not more than 0.20 N/55 mm, and separation by hand is easily possible.

◯: A peel force of not less than 0.20 N/55 mm and not more than 0.40 N/55 mm, and separation by hand is possible.

x: A peel force of more than 0.40 N/55 mm, and separation by hand is difficult.

Formulations of coating liquids for a transfer layer are summarized in the table below.

TABLE 1
[Composition of coating liquid for transfer layer]

| | | | | Cov- |
|---|---|---|---|---|
| Example No. | Group of resins | Mass | | erage |
| Ex. 1 | Polyester resin A1 | 0.05 | pt. mass | 1.0 |
| (only transfer | consisting of aliphatic | | | g/m² |
| layer) | alcohol alone | | | |
| | Polyester resin B1 | 9.95 | pts. mass | |
| | satisfying one of or both | | | |
| | (a) and (b) | | | |
| | Colorant | 17.5 | pts. mass | |
| | Acrylic resin | 7.8 | pts. mass | |
| | Toluene/methyl ethyl | 64.6 | pts. mass | |
| | ketone = 50/50 | | | |
| Ex. 2 | Polyester resin A1 | 1 | pt. mass | 1.0 |
| (only transfer | consisting of aliphatic | | | g/m² |
| layer) | alcohol alone | | | |
| | Polyester resin B1 | 4 | pts. mass | |
| | satisfying one of or both | | | |
| | (a) and (b) | | | |
| | Colorant | 17.5 | pts. mass | |
| | Acrylic resin | 12.8 | pts. mass | |
| | Toluene/methyl ethyl | 64.6 | pts. mass | |
| | ketone = 50/50 | | | |
| Ex. 3 | Polyester resin A2 | 0.05 | pt. mass | 1.0 |
| (only transfer | consisting of aliphatic | | | g/m² |
| layer) | alcohol alone | | | |
| | Polyester resin B2 | 9.95 | pts. mass | |
| | satisfying one of or both | | | |
| | (a) and (b) | | | |
| | Colorant | 17.5 | pts. mass | |
| | Acrylic resin | 7.8 | pts. mass | |
| | Toluene/methyl ethyl | 64.6 | pts. mass | |
| | ketone = 50/50 | | | |
| Ex. 4 | Polyester resin A2 | 1 | pt. mass | 1.0 |
| (only transfer | consisting of aliphatic | | | g/m² |
| layer) | alcohol alone | | | |
| | Polyester resin B2 | 4 | pts. mass | |
| | satisfying one of or both | | | |
| | (a) and (b) | | | |
| | Colorant | 17.5 | pts. mass | |
| | Acrylic resin | 12.8 | pts. mass | |
| | Toluene/methyl ethyl | 64.6 | pts. mass | |
| | ketone = 50/50 | | | |
| Ex. 5 | Polyester resin A1 | 0.05 | pt. mass | 1.0 |
| (only transfer | consisting of aliphatic | | | g/m² |
| layer) | alcohol alone | | | |
| | Polyester resin B3 | 9.95 | pts. mass | |
| | satisfying one of or both | | | |
| | (a) and (b) | | | |
| | Colorant | 17.5 | pts. mass | |
| | Acrylic resin | 7.8 | pts. mass | |
| | Toluene/methyl ethyl | 64.6 | pts. mass | |
| | ketone = 50/50 | | | |
| Ex. 6 | Polyester resin A1 | 1 | pt. mass | 1.0 |
| (only transfer | consisting of aliphatic | | | g/m² |
| layer) | alcohol alone | | | |
| | Polyester resin B3 | 4 | pts. mass | |
| | satisfying one of or both | | | |
| | (a) and (b) | | | |
| | Colorant | 17.5 | pts. mass | |
| | Acrylic resin | 12.8 | pts. mass | |
| | Toluene/methyl ethyl | 64.6 | pts. mass | |
| | ketone = 50/50 | | | |
| Ex. 7 | Polyester resin A1 | 0.4 | pt. mass | 1.0 |
| (only transfer | consisting of aliphatic | | | g/m² |
| layer) | alcohol alone | | | |
| | Polyester resin B1 | 4.6 | pts. mass | |
| | satisfying one of or both | | | |
| | (a) and (b) | | | |
| | Acrylic resin | 30.4 | pts. mass | |
| | Toluene/methyl ethyl | 64.6 | pts. mass | |
| | ketone = 50/50 | | | |
| Ex. 8 | Polyester resin A1 | 0.4 | pt. mass | 1.0 |
| (only transfer | consisting of aliphatic | | | g/m² |
| layer) | alcohol alone | | | |
| | Polyester resin B2 | 4.6 | pts. mass | |
| | satisfying one of or both | | | |
| | (a) and (b) | | | |
| | Acrylic resin | 30.4 | pts. mass | |
| | Toluene/methyl ethyl | 64.6 | pts. mass | |
| | ketone = 50/50 | | | |
| Ex. 9 | Polyester resin A1 | 0.4 | pt. mass | 1.0 |
| (only transfer | consisting of aliphatic | | | g/m² |
| layer) | alcohol alone | | | |
| | Polyester resin B3 | 4.6 | pts. mass | |
| | satisfying one of or both | | | |
| | (a) and (b) | | | |
| | Acrylic resin | 30.4 | pts. mass | |
| | Toluene/methyl ethyl | 64.6 | pts. mass | |
| | ketone = 50/50 | | | |
| Ex. 10 | Polyester resin A1 | 0.4 | pt. mass | 1.0 |
| (transfer | consisting of aliphatic | | | g/m² |
| layer) | alcohol alone | | | |
| | Polyester resin B3 | 4.6 | pts. mass | |
| | satisfying one of or both | | | |
| | (a) and (b) | | | |
| | Acrylic resin | 30.4 | pts. mass | |
| | Toluene/methyl ethyl | 64.6 | pts. mass | |
| | ketone = 50/50 | | | |
| Ex. 10 | Polyester resin | 24 | pts. mass | 1.5 |
| (adhesive | | | | g/m² |
| layer) | Ultraviolet absorber acrylic | 6 | pts. mass | |
| | copolymer | | | |
| | Toluene/methyl ethyl | 70 | pts. mass | |
| | ketone = 50/50 | | | |
| Ex. 11 | Polyester resin A1 | 0.4 | pt. mass | 1.0 |
| (only transfer | consisting of aliphatic | | | g/m² |
| layer) | alcohol alone | | | |
| | Polyester resin B3 | 4.6 | pts. mass | |
| | satisfying one of or both | | | |
| | (a) and (b) | | | |
| | Colorant | 17.5 | pts. mass | |
| | Acrylic resin | 12.1 | pts. mass | |
| | Polyethylene wax | 0.7 | pt. mass | |
| | Toluene/methyl ethyl | 64.6 | pts. mass | |
| | ketone = 50/50 | | | |
| Comp. Ex. 1 | Polyester resin A1 | 1 | pt. mass | 1.0 |
| (only transfer | consisting of aliphatic | | | g/m² |
| layer) | alcohol alone | | | |
| | Colorant | 17.5 | pts. mass | |
| | Acrylic resin | 17.8 | pts. mass | |
| | Toluene/methyl ethyl | 64.6 | pts. mass | |
| | ketone = 50/50 | | | |
| Comp. Ex. 2 | Polyester resin A1 | 0.05 | pt. mass | 1.0 |
| (only transfer | consisting of aliphatic | | | g/m² |
| layer) | alcohol alone | | | |
| | Colorant | 17.5 | pts. mass | |
| | Acrylic resin | 17.75 | pts. mass | |
| | Toluene/methyl ethyl | 64.6 | pts. mass | |
| | ketone = 50/50 | | | |
| Comp. Ex. 3 | Polyester resin A1 | 10 | pts. mass | 1.0 |
| (only transfer | satisfying one of or both | | | g/m² |
| layer) | (a) and (b) | | | |
| | Colorant | 17.5 | pts. mass | |
| | Acrylic resin | 7.8 | pts. mass | |
| | Toluene/methyl ethyl | 64.6 | pts. mass | |
| | ketone = 50/50 | | | |
| Comp. Ex. 4 | Polyester resin A2 | 10 | pts. mass | 1.0 |
| (only transfer | satisfying one of or both | | | g/m² |
| layer) | (a) and (b) | | | |
| | Colorant | 17.5 | pts. mass | |
| | Acrylic resin | 7.8 | pts. mass | |
| | Toluene/methyl ethyl | 64.6 | pts. mass | |
| | ketone = 50/50 | | | |
| Comp. Ex. 5 | Polyester resin A3 | 10 | pts. mass | 1.0 |
| (only transfer | satisfying one of or both | | | g/m² |
| layer) | (a) and (b) | | | |
| | Colorant | 17.5 | pts. mass | |
| | Acrylic resin | 7.8 | pts. mass | |
| | Toluene/methyl ethyl | 64.6 | pts. mass | |
| | ketone = 50/50 | | | |

Properties of polyester resins in which the alcohol component consists of an aliphatic alcohol only, and the compositions of the resins are shown in the table below.

TABLE 2

| | | | Alcohol | | |
|---|---|---|---|---|---|
| | Glass | Number aver- | component, | | |
| | transition | age molecular | mol % | | |
| Polyester resin No. | point, ° C. | weight | EG | NPG | BPA |
| Polyester resin A1 in | 67 | 20000 | 50 | 50 | — |
| which alcohol | | | | | |
| component consists of | | | | | |
| aliphatic alcohol only | | | | | |
| Polyester resin A2 in | 53 | 2000 | 50 | 50 | — |
| which alcohol | | | | | |
| component consists of | | | | | |
| aliphatic alcohol only | | | | | |

EG: ethylene glycol; NPG: neopentyl glycol; BPA: bisphenol A

Properties of polyester resins satisfying one of or both the above property requirement (a) and property requirement (b) are shown in the table below.

TABLE 3

| Polyester resin No. | Classification | Remarks |
|---|---|---|
| Polyester resin A1 | (a) | Bisphenol A component |
| satisfying one of or both | | present, number average |
| (a) and (b) | | molecular weight 22000 |
| Polyester resin A2 | (b) | Softening point 110° C. as |
| satisfying one of or both | | measured by ring and ball |
| (a) and (b) | | method specified in JIS K |
| | | 5601-2-2 |
| Polyester resin A3 | (a) + (b) | Bisphenol A component |
| satisfying one of or both | | present, number average |
| (a) and (b) | | molecular weight 15000 |
| | | Softening point 105° C. as |
| | | measured by ring and ball |
| | | method specified in JIS K |
| | | 5601-2-2 |

Evaluation results are shown in the table below.

TABLE 4

| | | | | | Peelability in | Peelability in |
|---|---|---|---|---|---|---|
| | | | | | thermal | thermal |
| | | Linear | Unsatu- | Adhesion | transfer | transfer |
| Example | Con- | saturated | rated | to base | (instantaneous | (peelability |
| No. | struction | Pes | Pes | material | peelability) | after 30 sec.) |
| Ex. 1 | Single | Present | (a) | ⊚ | ⊚ | ∘ |
| | layer | | | | | |
| Ex. 2 | Single | Present | (a) | ⊚ | ⊚ | ∘ |
| | layer | | | | | |
| Ex. 3 | Single | Present | (b) | ∘ | ⊚ | ∘ |
| | layer | | | | | |
| Ex. 4 | Single | Present | (b) | ⊚ | ⊚ | ∘ |
| | layer | | | | | |
| Ex. 5 | Single | Present | (a) + (b) | ∘ | ⊚ | ⊚ |
| | layer | | | | | |
| Ex. 6 | Single | Present | (a) + (b) | ⊚ | ⊚ | ⊚ |
| | layer | | | | | |
| Ex. 7 | Single | Present | (a) | ⊚ | ⊚ | ∘ |
| | layer | | | | | |
| Ex. 8 | Single | Present | (b) | ∘ | ⊚ | ∘ |
| | layer | | | | | |
| Ex. 9 | Single | Present | (a) + (b) | ⊚ | ⊚ | ⊚ |
| | layer | | | | | |
| Ex. 10 | Transfer | Present | (a) + (b) | ⊚ | ⊚ | ⊚ |
| | layer + | | | | | |
| | adhesive | | | | | |
| | layer | | | | | |
| Ex. 11 | Single | Present | (a) + (b) | ⊚ | ⊚ | ⊚ |
| | layer | | | | | |
| Comp. | Single | Present | Absent | ⊚ | ∘ | x |
| Ex. 1 | layer | | | | | |
| Comp. | Single | Present | Absent | x | ⊚ | ⊚ |
| Ex. 2 | layer | | | | | |
| Comp. | Single | Absent | (a) | x | ⊚ | ⊚ |
| Ex. 3 | layer | | | | | |
| Comp. | Single | Absent | (b) | x | ∘ | ∘ |
| Ex. 4 | layer | | | | | |
| Comp. | Single | Absent | (a) + (b) | x | ⊚ | ⊚ |
| Ex. 5 | layer | | | | | |

[Evaluation Method]
Adhesion to Base Material:

Cello-Tape manufactured by Nichiban Co., Ltd. (for industrial use) (No. 405-1P) having a size of 18 mm×70 m was applied to the thermal transfer sheet on its transfer layer side and was then separated. In this case, whether or not the transfer layer is transferred to the tape was visually inspected.
⊚: The transfer layer was not transferred to the tape at all.
◯: The transfer layer was hardly transferred to the tape, although a part thereof was transferred to the tape.
x: The transfer layer was almost transferred to the tape.
   Separability at the Time of Thermal Transfer:

Printing was carried out on a film manufactured by Sekisui Chemical Co., Ltd. (tradename: Tack Paint, color number TP02) as an object under the following printing conditions. The prints were used for the evaluation of separability.

(Printing Conditions)

Thermal head: KGT-217-12 MPL20 (manufactured by Kyocera Corp.)

Heating element average resistance value: 3195 (Ω)

Printing density in main scanning direction: 300 dpi

Printing density in feed direction: 300 dpi

Applied power: 0.13 (w/dot)

One line period: 5 (msec.)

Printing initiation temp.: 40 (° C)

Gradation control method: A test printer of a multi-pulse system was provided which had such a pulse length that one line period was divided into 256 equal parts and wherein the number of divided pulses could be varied from 0 to 255 during one line period. The duty ratio of each divided pulse was fixed at 80%, and transfer was carried out in 255 gradations in a range from the printing start part to the printing end part. The print range was 100 mm in length (printing direction)×55 mm in width.

Separability at the Time of Thermal Transfer (Instantaneous Separability):

Immediately after printing under the above conditions, the thermal transfer sheet was separated from an object by hand. The force necessary for the separation by hand was sensorily evaluated.

⊚: Easily separable

◯: Separable

x: Difficult to separate

Separability at the Time of Thermal Transfer (Separability after 30 Sec)

Upon the elapse of 30 sec after printing under the above conditions, the force necessary for separating the thermal transfer sheet from the object (peel force) was measured using a T-shaped peeling tool specified in JIS P 8139 under the following conditions with HEIDON 140R, manufactured by Shinto Scientific Company Ltd.

Measuring conditions: Test table travel speed 1000 mm/min; travel distance: 100 mm

⊚: A peel force of not more than 0.20 N/55 mm, and separation by hand is easily possible.

◯: A peel force of not less than 0.20 N/55 mm and not more than 0.40 N/55 mm, and separation by hand is possible.

x: Impossible to separate

As a result, it was found that, for all of Examples 1 to 11, all of the adhesion between the base material sheet and the transfer layer, the separability immediately after heating at the time of thermal transfer, that is, separability while hot, and the separability after the elapse of 30 sec from the thermal transfer, that is, separability while cold, were acceptable. On the other hand, Comparative Example 1 suffered from a problem of separability while cold in the thermal transfer. Further, Comparative Examples 2, 3, 4, and 5 suffered from a problem of the adhesion between the base material sheet and the transfer layer. That is, the transfer layer was disadvantageously easily peeled down from the base material sheet, that is, disadvantageously easily separated down.

As described above, in the present invention, at least two polyester resins are contained in the transfer layer. In this case, one of the two polyester resins is a saturated polyester resin having a glass transition point of 50° C. or above and a number average molecular weight of 2000 to 25000, and the other polymer resin is a polyester resin satisfying one of or both a property requirement (a) and a property requirement (b). According to this construction, a thermal transfer sheet can be realized which has good adhesion between the transfer layer and the base material and good separability at the time of thermal transfer (good separability even in separation while cold).

1. A thermal transfer sheet comprising: a base material sheet; and a thermally transferable transfer layer provided on at least a part of one side of the base material sheet, wherein
said transfer layer is formed of at least two polyester resins, and one of the two polyester resins is a polyester resin having a glass transition point of 50° C. or above and a number average molecular weight of 2000 to 20000, an alcohol component in the polyester resin being composed of an aliphatic alcohol alone, and the other polymer resin is a polyester resin satisfying one of or both a property requirement (a) and a property requirement (b):
(a) a bisphenol A component being present as an alcohol component, and the number average molecular weight being not more than 25000; and
(b) a softening point of 110° C. or below as measured by a ring and ball method specified in JIS K 5601-2-2.

2. The thermal transfer sheet according to claim 1, wherein the mixing ratio between the two polyester resins in the transfer layer is polyester resin of which the alcohol component is composed of an aliphatic alcohol alone/polyester resin satisfying one of or both a property requirement (a) and a property requirement (b)=0.5/99.5 to 20/80.

3. The thermal transfer sheet according to claim 1, wherein said transfer layer comprises a colorant and an acrylic resin.

4. The thermal transfer sheet according to claim 1, wherein said transfer layer comprises an acrylic resin, is transparent and is transferred onto an image receiving sheet to function as a protective layer for the image receiving sheet.

5. The thermal transfer sheet according to claim 1, which further comprises an adhesive layer on said transfer layer.

6. The thermal transfer sheet according to claim 1, wherein one of or both the front surface and the back surface have an antistatic property.
